(19) United States
(12) Patent Application Publication
(10) Pub. No.: US 2016/0080596 A1
(43) Pub. Date: Mar. 17, 2016

(54) IMAGE-READING DEVICE, COMMUNICATION DEVICE, AND IMAGE-FORMING DEVICE

(71) Applicant: KYOCERA Document Solutions Inc., Osaka (JP)

(72) Inventor: Yasuhiro SEKIGUCHI, Osaka (JP)

(73) Assignee: KYOCERA DOCUMENT SOLUTIONS INC., Osaka (JP)

(21) Appl. No.: 14/485,197

(22) Filed: Sep. 12, 2014

(51) Int. Cl. H04N 1/00

(52) U.S. Cl. CPC H04N 1/00777; H04N 1/00395; H04N 1/00474; H04N 1/0049; H04N 1/00482; H04N 1/0048; H04N 1/00708; H04N 1/00771

(57) ABSTRACT

An image-reading device: detects, after a starting operation for starting a job has been performed on an operation part, the size of a document loaded on a document-loading tray; and when there is a difference between the size of the document detected before the starting operation and the size of the document detected after the starting operation, temporarily stops the job without resetting a setting received by the operation part prior to the start of the job.

### INCORPORATION BY REFERENCE

This application is based upon and claims the benefit of priority from the corresponding Japanese Patent Application No. 2013-200004, filed Sep. 26, 2013, the entire contents of which are incorporated herein by reference.

### BACKGROUND OF THE INVENTION

The present disclosure relates to an image-reading device for transporting and reading a document, a communication device, and an image-forming device.

Conventionally, there are known image-reading devices capable of performing transporting-reading in which a document passing on contact glass (reading position) is read. An image-reading device of such description is provided with a document transportation unit for transporting a document to the reading position.

The document transportation unit comprises elements such as a document-loading tray on which the document is loaded, a document transportation path extending from the document-loading tray to the reading position, and a transportation roller for transporting the document along the document transportation path. A document size sensor for detecting the size of the document loaded on the document-loading tray is provided to the document-loading tray.

An operation panel is normally fitted to an image-reading device. Through the operation panel, the image-forming device receives, e.g., an input of a setting relating to a job or a starting operation for starting a job.

A user wishing to execute a job involving transporting-reading first positions the document on the document-loading tray. The user also inputs a setting relating to the job when required (i.e., when the setting relating to the job is to be changed from a default value to a desired value). The user then performs the starting operation on the operation panel.

When the document is loaded on the document-loading tray, the image-reading device detects the size of the document loaded on the document-loading tray on the basis of an output value from the document size sensor. Upon detecting the size of the document, the image-reading device causes the operation panel to receive the input of the setting relating to the job. Then, upon receiving the starting operation performed on the operation panel, the image-reading device starts the job.

Examples of settings received by the operation panel prior to the start of the job include a setting for setting the reading size for reading the document. Accordingly, the operation panel displays, and allows the user to establish, the size of the document currently loaded on the document-loading tray. For example, the user sets the setting for the reading size to “automatic.” When the setting for the reading size is set to “automatic”, the reading size is not automatically on the basis of the size of the document currently loaded on the document-loading tray. Alternatively, the user sets an arbitrary value as the setting for the reading size.

For example, when the user realizes, after performing a starting operation on the operation panel, that the document loaded on the document-loading tray is different from the desired document, the document may be removed from the document-loading tray and retained, or the document loaded on the document-loading tray may be replaced with a document having a different size from that of the document loaded on the document-loading tray. Depending on the image-reading device, when the document is removed or replaced, the job is terminated and all settings relating to the job received by the operation panel prior to the start of the job are reset.

However, depending on the user, the user may wish to restart the job while maintaining the setting (setting other than the reading size) inputted prior to the start of the job. For a user of such description, a configuration in which all of the settings inputted prior to the start of the job are reset will require that the settings inputted into the operation panel prior to the start of the job are re-inputted, and is therefore inconvenient.

### SUMMARY OF THE INVENTION

An image-reading device according to a first aspect of the present disclosure comprises an operation part, a document-loading tray, a document transportation part, an image-reading part, a document size sensor, and a controller. The operation part receives an input of a setting relating to a job, and receives a starting operation for starting a job. A document is loaded on the document-loading tray. The document transportation part transports the document loaded on the document-loading tray to a reading position during execution of the job. The image-reading part reads the document passing through the reading position during execution of the job. The document size sensor detects the size of the document loaded on the document-loading tray. The controller detects the size of the document on the basis of an output value from the document size sensor when the document is loaded on the document-loading tray, starts the job when the starting operation is performed on the operation part, and controls the execution of the job in accordance with the setting received by the operation part prior to the start of the job. The controller detects, after the starting operation is performed on the operation part, the size of the document loaded on the document-loading tray, and when there is a difference between the size of the document detected prior to the starting operation and the size of the document after the starting operation, temporarily stops the job without resetting the setting received by the operation part prior to the start of the job.

A communication device according to a second aspect of the present disclosure comprises the above image-reading device and a communication part. The communication part is communicably connected to an external device, and the communication part transmits, to the external device, image data obtained by the document being read by the image-reading part. The job is a transmission job for transmitting, to the external device, the image data corresponding to the document.

An image-forming device according to a third aspect of the present disclosure comprises the above image-reading device and a printing part. The printing part prints, onto paper, an image based on image data obtained by the document being read by the image-reading part. The job is a copy job for printing, onto paper, the image based on the image data corresponding to the document.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram of a copier according to an embodiment of the present disclosure;

FIG. 2 is a block diagram illustrating the hardware configuration of the copier according to an embodiment of the present disclosure;

FIG. 3 is a block diagram illustrating the hardware configuration of an image-reading part, onto which a document transportation unit has been mounted, of the copier according to an embodiment of the present application;

FIG. 4 shows an example of a screen displayed on the operation panel of the copier according to an embodiment of the present application (size setting screen for receiving input of the setting for the reading size);

FIG. 5 shows an example of a screen displayed on the operation panel of the copier according to an embodiment of the present application (size setting screen for receiving input of the setting for the reading size);

FIG. 6 shows an example of a screen displayed on the operation panel of the copier according to an embodiment of the present application (notification screen for prompting the user to reload the document or input a setting for the reading size);

FIG. 7 is a flow chart illustrating the control flow when a job is executed in the copier according to an embodiment of the present disclosure; and

FIG. 8 is a flow chart illustrating the control flow when a job is executed in the copier according to an embodiment of the present disclosure.

### DETAILED DESCRIPTION OF THE EMBODIMENTS

An embodiment of the present disclosure will now be described using an example of a copier capable of executing a print job, a copy job, a box job, and a transmission job (e.g., a fax job). The copier corresponds to the “image-reading device”, “communication device”, and the “image-forming device”.

(Overall Configuration of Copier)

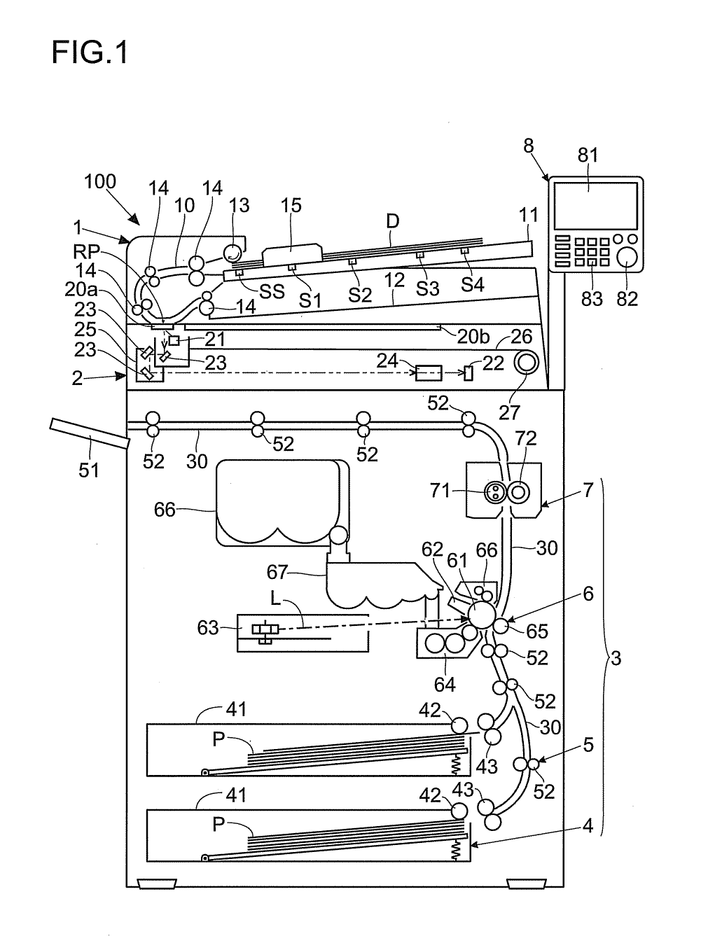

As shown in FIG. 1, the copier 100 of the present embodiment is provided with an image-reading part 2 onto which a document transportation unit 1 is mounted, a printing part 3 (a paper feed part 4, a paper transportation part 5, an image-forming part 6, and a fixing part 7), and an operation panel 8 (corresponding to an “operation part” and a “notification part”).

The image-reading part 2 onto which the document transportation unit 1 has been mounted has a frame (reading platform) into which contact glass 20a for transporting-reading and contact glass 20b for placement reading have been fitted. The image-reading part 2 performs transporting-reading for reading the document D passing over the contact glass 20a or placement reading for reading the document D passing over the contact glass 20b. It is thereby possible to store the image data obtained by reading the document D in a storage region called a box in the device (box job). The storage region used in the box job is provided, e.g., to a memory part 113 described further below.

The document transportation unit 1 is attached to the frame of the image-reading part 2 so as to be capable of opening/closing (capable of rotating). Transportation of the document D onto the contact glass 20a is performed by the document transportation unit 1. Specifically, the document transportation unit 1 includes a document-loading tray 11, a document discharge tray 12, a paper feed roller 13 (corresponding to the “document transportation part”), and transportation roller pairs 14 (corresponding to the “document transportation part”). A document transportation path 10, which leads from the document-loading tray 11 to the document discharge tray 12 through a position on the contact glass 20a (hereafter referred to as a reading position RP) representing a reading position during transporting-reading, is provided to the document transportation unit 1.

The document-loading tray 11 is a tray on which the document D prior to being read is loaded, and the document discharge tray 12 is a tray onto which the document D after being read is discharged. A pair of restricting plates 15 for sandwiching the document D in the main scan direction (direction perpendicular to the plane of the diagram in FIG. 1) and performing loading in the main scan direction are provided to the document-loading tray 11. FIG. 1 shows only one of the pair of restricting plates 15. The restricting plates 15 are capable of sliding in the main scan direction in linkage with each other; causing one of the restricting plates 15 to slide causes the other restricting plate 15 to also slide. However, the restricting plates 15 slide in opposite directions to each other. In other words, the restricting plates 15 slide away or towards each other.

The paper feed roller 13 and the transportation roller pairs 14 transport the document D loaded on the document-loading tray 11 to the reading position RP and discharge the document D onto the document discharge tray 12. The paper feed roller 13 is positioned furthest upstream on the document transportation path 10, and feeds the document D loaded on the document-loading tray 11 to the document transportation path 10. A plurality of the transportation roller pairs 14 are provided along the document transportation path 10, and together with the paper feed roller 13, transport the document D along the document transportation path 10. The document D transported along the document transportation path 10 by the paper feed roller 13 and the transportation roller pairs 14 is caused to pass through the reading position RP and are ultimately discharged onto the document discharge tray 12. From the arrival of the document D at the reading position RP and until the document D leaves the reading position RP, the image-reading part 2 reads the document D at the reading position RP.

A document loading sensor SS for detecting the presence/absence of the document D on the document-loading tray 11 is provided to the document transportation unit 1. The document loading sensor SS is, e.g., an actuator-type optical sensor having a light-emitting part, a light-receiving part, and an actuator which moves between the light-emitting part and the light-receiving part and protrudes onto a region on the document-loading tray 11 (region on which the document D is loaded). When the document D is present on the document-loading tray 11, the actuator of the document loading sensor SS is pressed by the document D and is caused to move downwards, blocking (or clearing) the light path between the light-emitting part and the light-receiving part. When the document D is no longer on the document-loading tray 11, the actuator of the document loading sensor SS is caused to move upwards due to being released from the pressing force from the document D, clearing (or blocking) the light path between the light-emitting part and the light-receiving part. The output value from the document loading sensor SS is thereby different depending on whether or not the document D is present on the document-loading tray 11. Therefore, it is possible to detect, on the basis of the output value from the document loading sensor SS, whether or not the document D has been loaded on the document-loading tray 11.

The document transportation unit 1 is further provided with document size sensors S1, S2, S3, and S4 for detecting the size of the document D loaded on the document-loading tray 11. The document size sensor S1 is a sensor for detecting the size of the document D in the main scan direction. The document size sensor S1 is, e.g., a variable resistor, and the output value (resistance value) is varied according to the position of the restricting plates 15 in the main scan direction. It is thereby possible to detect the size of the document D in the main scan direction on the basis of the output value from the document size sensor S1.

The document size sensors S2-S4 are sensors for detecting the size of the document D in a sub-scan direction orthogonal to the main scan direction of the document D, and are disposed at a predetermined spacing from each other in the sub-scan direction. The document size sensors S2-S4 are, e.g., actuator-type optical sensors, and the output value is varied by the actuator being pressed by the document D loaded on the document-loading tray 11. It is therefore possible to identify the document size sensor, from among the document size sensors S2-S4, that reaches the H level (or the L level), and thereby detect the size of the document D in the sub-scan direction.

The image-reading part 2 includes a lamp 21, an image sensor 22, a mirror 23, and a lens 24, and optically reads the document D. Each of the members constituting the image-reading part 2 is disposed in the frame of the image-reading part 2.

The lamp 21 has a plurality of LED elements, and generates light to be directed onto the document D. The LED elements are arranged in a line in the main scan direction (although not shown). During transporting-reading, the lamp 21 directs light towards the contact glass 20a (light that has been transmitted through the contact glass 20a is directed onto the document D). During placement reading, the lamp 21 directs light towards the contact glass 20b (light that has been transmitted through the contact glass 20b is directed onto the document D. Reflected light reflected by the document D is reflected by the mirror 23 and guided to the lens 24. The lens 24 collects the reflected light.

The image sensor 22 receives the reflected light reflected by the document D (i.e., light collected by the lens 24) and thereby reads the document D in line units. The image sensor 22 comprises a CCD having a plurality of photoelectric conversion elements arranged in a line along the main scan direction. Upon receiving the reflected light, the image sensor 22 performs photoelectric conversion and accumulates a charge with respect to each pixel, in line units. The image sensor 22 then outputs an analog signal corresponding to the accumulated charge. Specifically, the analog output for each pixel from the image sensor 22 varies according to the amount of reflected light.

The lamp 21 and the mirror 23 are held by a holding member 25 capable of moving in the sub-scan direction. The holding member 25 is linked to a wire 26. The wire 26 is wound around a winding drum 27. Therefore, a rotation of the winding drum 27 moves the holding member 25 in the sub-scan direction and moves the lamp 21 and the mirror 23 with the holding member 25 in the sub-scan direction. During transporting-reading, the holding member 25 is stationary below the contact glass 20a. During placement reading, the holding member 25 moves in the sub-scan direction (left to right when viewed from the front).

The printing part 3 comprises the paper feed part 4, the paper transportation part 5, the image-forming part 6, and the fixing part 7. The printing part 3 transports paper P along a paper transportation path 30, and prints onto the paper P, and outputs, e.g., an image based on image data obtained the image-reading part 2 reading the document D.

The paper feed part 4 feeds the paper P housed in a paper cassette 41 to the paper transportation path 30. The paper feed part 4 includes a pickup roller 42 and a paper feed roller pair 43. The pickup roller 42 sends the paper P housed in the paper cassette 41 to a paper feed nip of the paper feed roller pair 43, and the paper feed roller pair 43 feeds the paper P entering the paper feed nip to the paper transportation path 30.

The paper transportation part 5 transports the paper P fed to the paper transportation path 30 through a transfer nip and a fixing nip, in the sequence listed, and discharges the paper P onto a discharge tray 51. The paper transportation part 5 includes a plurality of transportation roller pairs 52 disposed along the paper transportation path 30.

The image-forming part 6 forms a toner image on the basis of the image data and transfers the toner image onto the paper P. The image-forming part 6 includes a photosensitive drum 61, a charge device 62, an exposure device 63, a development device 64, a transfer roller 65, and a cleaning device 66

During image formation, the photosensitive drum 61 rotates, and the charge device 62 charges the surface of the photosensitive drum 61 to a predetermined potential. The exposure device 63 exposes the surface of the photosensitive drum 61 through scanning, and forms an electrostatic latent image on the surface of the photosensitive drum 61. The development device 64 feeds a toner to the electrostatic latent image formed on the surface of the photosensitive drum 61 and develops an image. A container 66 for housing the toner to be supplied is mounted in the copier 100. The toner housed in the container is supplied to the development device 64 through an intermediate hopper 67.

The transfer roller 65 presses against the surface of the photosensitive drum 61 and forms a transfer nip therebetween. When the paper P enters the transfer nip, the toner image on the surface of the photosensitive drum 61 is transferred onto the paper P. When the transferring of the toner image onto the paper P has ended, the container 66 removes the toner remaining on the surface of the photosensitive drum 61.

The fixing part 7 fixes the toner image transferred onto the paper P by heating and pressing the toner image. The fixing part 7 includes a heating roller 71 and a pressing roller 72. The heating roller 71 is internally provided with a heating source. The pressing roller 72 presses against the heating roller 71 and forms a fixing nip therebetween. The paper P onto which the toner image has been transferred is passed through the fixing nip and thereby heated and pressed.

The operation panel 8 receives inputs of settings relating to a job and receives a starting operation for starting a job. The operation panel 8 includes a liquid crystal display part 81 (corresponding to a “display part”) having a touch panel. The liquid crystal display part 81 displays, e.g., a message, or soft keys for receiving inputs of settings relating to the job. The operation panel 8 is also provided with hard keys such as a start key 82 or a ten-key 83. The start key 82 is a hard key for receiving the starting operation for a job. The ten-key 83 comprises hard keys pressed when a setting relating to a job is inputted numerically.

(Hardware Configuration of Copier)

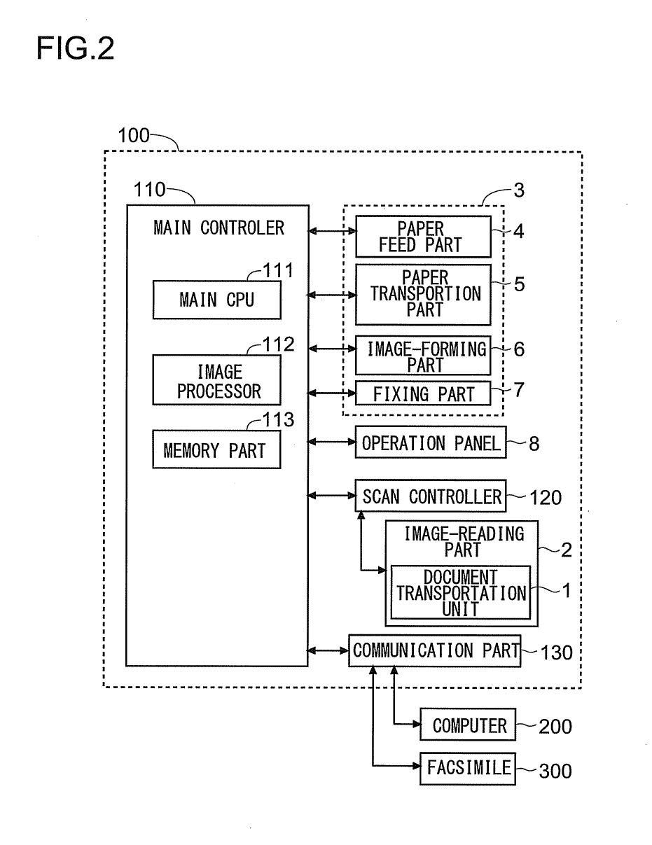

As shown in FIG. 2, the copier 100 is provided with a main controller 110 (corresponding to a “controller”). The main controller 110 includes a main CPU 111, an image processor 112, and a memory part 113. The image processor 112 comprises, e.g., an ASIC dedicated for image processing, and performs image processing (e.g., enlarging/shrinking, density conversion, or data format conversion) on the image data. The memory part 113 comprises a ROM and a RAM or the like and stores programs and data. The main controller 110 controls the action of each part of the copier 100 on the basis of the programs and data stored in the memory part 113. For example, the main controller 110 is connected to the printing part 3 and controls the printing action by the printing part 3.

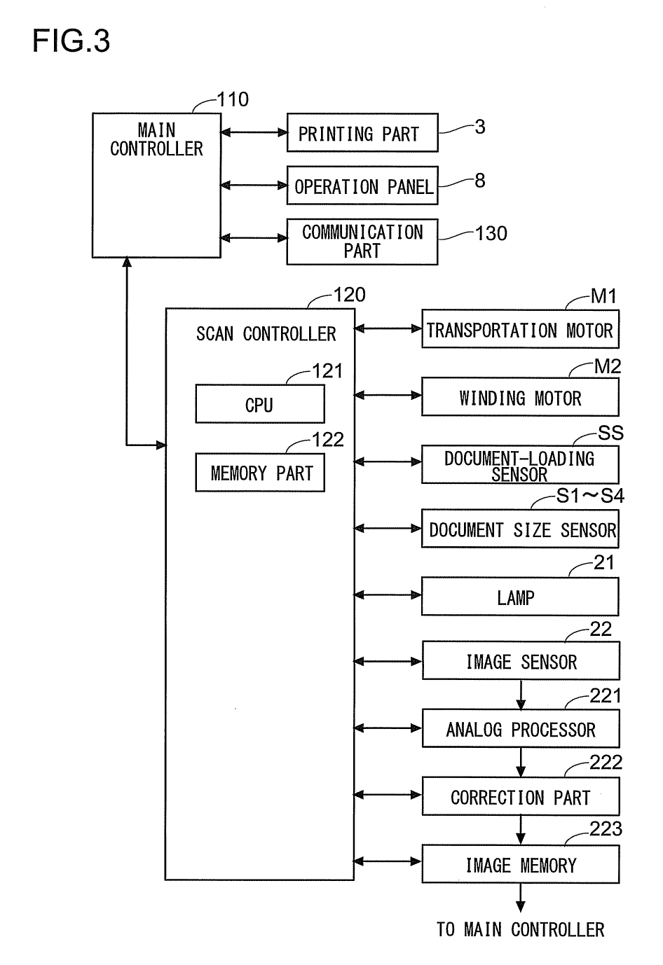

A scan controller 120 (corresponding to a “controller”) is connected to the main controller 110. As shown in FIG. 3, the scan controller 120 includes a CPU 121 and a memory part 122. The scan controller 120 receives a command from the main controller 110, and controls the document transportation action of the document transportation unit 1 and the image-reading action of the image-reading part 2.

Specifically, the scan controller 120 is connected to a transportation roller M1 for causing the paper feed roller 13 and the transportation roller pairs 14 to rotate, and the scan controller 120 causes the paper feed roller 13 and the transportation roller pairs 14 to rotate in an appropriate manner. In addition, the scan controller 120 is connected to a winding motor M2 for causing the winding drum 27 to rotate, and the scan controller 120 causes the winding drum 27 to rotate in an appropriate manner. Specifically, the scan controller 120 moves the lamp 21 (holding member 25) appropriately in the sub-scan direction.

The lamp 21 and the image sensor 22 are also connected to the scan controller 120. The scan controller 120 controls the actions of the lamp 21 and the image sensor 22. In addition, the scan controller 120 is connected to an analog processor 221, a correction part 222, and an image memory 223 in order to process the analog output of the image sensor 22. The analog processor 221 includes, e.g., an amplification circuit and an ND conversion circuit, and the analog output of the image sensor 22 is amplified, converted into digital image data, and outputted by the analog processor 221. The correction part 222 performs correction such as shading correction. The image memory 223 accumulates image data and transfers the image data to the main controller 110 (image processor 112).

The scan controller 120 is connected to the document loading sensor SS, and detects whether or not the document D has been loaded on the document-loading tray 11 on the basis of an output value from the document loading sensor SS. In addition, the scan controller 120 is connected to the document size sensors S1-S4, and detects the size of the document D loaded on the document-loading tray 11 on the basis of the output values from the document size sensors S1-S4.

Back to FIG. 2, a communication part 130 is connected to the main controller 110. The communication part 130 is communicably connected to, e.g., an external computer 200 (corresponding to an “external device”) over a network. It is thereby possible to perform printing on the basis of image data transmitted from the computer 200 (i.e., print job). It is also possible to transmit image data obtained by reading the document D to the computer 200 (i.e., transmission job). The communication part 130 is also internally provided with a modem. Therefore, it is possible to communicate by fax with an external facsimile 300 (corresponding to an “external device”) over a network such as a telephone line (i.e., fax job).

The main controller 110 is also connected to the operation panel 8. The main controller 110 performs operations such as controlling the display action performed by the operation panel 8 and detecting an operation performed on the operation panel 8. For example, when a job is not being executed, the main controller 110 causes the operation panel 8 to display a setting screen for receiving an input of a setting relating to a job. The setting screen displayed in such an instance can be changed; for example, a setting screen for a copy job can be displayed, or a setting screen for a job other than a copy job can be displayed. When a starting operation for starting a job (i.e., an operation for pressing the start key 82) is performed on the operation panel 8, the main controller 110 starts the job.

The main controller 110 and the scan controller 120 may or may not be divided from each other. In other words, the controls performed by the main controller 110 and the controls performed by the scan controller 120 may be performed by a single controller (e.g., the main controller 110).

(Overview of Job Involving Transporting-Reading)

Examples of a job involving transporting-reading include a copy job, a box job, and a transmission job (fax job). In an instance in which the user wishes to perform a job of such description, the document D is loaded on the document-loading tray 11 and settings relating to the job are inputted into the operation panel 8. For example, the operation panel 8 receives inputs of settings for a variety of setting items such as enlargement/reduction, document image quality, reading resolution, density, file format, frame elimination, sharpness, and ground color adjustment. With regards to a transmission job, address information (e.g., a fax number) also corresponds to a setting. Then, the starting operation is subsequently performed on the operation panel 8.

When the document D is loaded on the document-loading tray 11, the output value from the document loading sensor SS indicates the presence of the document D. The scan controller 120 thereby detects that the document D has been loaded on the document-loading tray 11. When the document D has been loaded on the document-loading tray 11, the scan controller 120 detects the size of the document D loaded on the document-loading tray 11 on the basis of the out values from the document size sensors S1-84. An irregular-sized document D may be loaded on the document-loading tray 11. In such an instance, the scan controller 120 detects that the size of the document D loaded on the document-loading tray 11 is irregular. Then, the scan controller 120 notifies the main controller 110 with document size information indicating the size of the document D loaded on the document-loading tray 11.

The main controller 110, upon being notified with the document size information, causes the operation panel 8 to receive inputs of settings relating to the job. In other words, the operation panel 8 displays a setting screen for the job (or continues displaying the setting screen in an instance in which the setting screen is already being displayed). The setting screen for the job displayed at this time includes information indicating the size of the document D loaded on the document-loading tray 11.

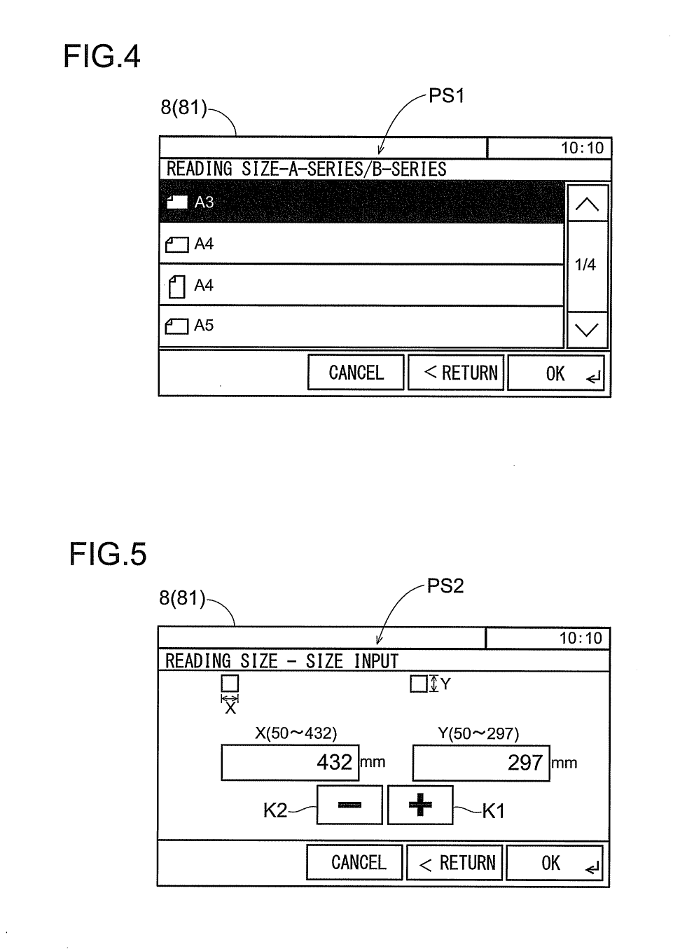

For example, the operation panel 8 receives an input of a setting for setting the reading size used by the image-reading part 2 to read the document D as a setting relating to the job. When receiving an input of the setting for the reading size, the operation panel 8 displays, from amongst a size setting screen PS1 such as that shown in FIG. 4 and a size setting screen PS2 such as that shown in FIG. 5, a size setting screen selected by the user. Then, the main controller 110 sets the reading size on the basis of the setting inputted into the operation panel 8.

The size setting screen PS1 is a screen for selecting and designating the reading size from a plurality of standard sizes. In the size setting screen PS1, when, e.g., the top box is touched, the reading size is set to A3. The size setting screen PS2 is a screen for designating an arbitrary reading size. In this size setting screen PS2, it is possible to designate an arbitrary width for the reading size in the main scan direction (X-direction) and the sub-scan direction (Y-direction) through touching a plus key K1 and a minus key K2. In an instance in which an irregular-sized document D is loaded on the document-loading tray 11, the reading size must be designated using the size setting screen PS2.

One of the settings for the reading size is “automatic”. In an instance in which the setting for the reading size is set to “automatic”, the main controller 110 sets the reading size on the basis of the size of the document D loaded in the document-loading tray 11. Specifically, when the size of the document D detected when the document D is loaded on the document-loading tray 11 is A4, the main controller 110 sets the reading size to A4. Normally, the default setting for the reading size is set to “automatic”.

After notification of the document size information has taken place, upon the starting operation being performed on the operation panel 8, the main controller 110 starts the job. Specifically, the main controller 110 first makes an image-reading request to the scan controller 120. Upon receiving the image-reading request, the scan controller 120 notifies the main controller 110 that image reading will be performed. Then, the scan controller 120 causes the document transportation unit 1 to transport the document D. The scan controller 120 also causes the image-reading part 2 to read the document D.

(Temporary Stoppage of Job Involving Transporting-Reading)

After the starting operation is performed on the operation panel 8, the main controller 110 commands the scan controller 120 to detect the size of the document D loaded on the document-loading tray 11 and determine whether or not there is a difference in detection results (i.e., the size of the document D loaded on the document-loading tray 11) before and after the starting operation performed on the operation panel 8. Upon determining that there is a difference in the size of the document D before and after the starting operation performed on the operation panel 8, the scan controller 120 issues, as a response to the image-reading request from the main controller 110, a notification indicating that there is a difference in the size of the document D before and after the starting operation performed on the operation panel 8 (i.e., a size mismatch).

For example, in an instance in which, after the starting operation has been performed on the operation panel 8, the document D loaded on the document-loading tray 11 is removed and retained (i.e., the document-loading tray 11 no longer contains a document D), the scan controller 120 notifies the main controller 110 of the size mismatch. In such an instance, the scan controller 120 may also notify the main controller 110 of the size mismatch when the output value of the document loading sensor SS is at a level indicating the absence of the document D. The scan controller 120 also notifies the main controller 110 of the size mismatch when a document D having a predetermined standard size is replaced with a document D having another standard size, or when a document D having a standard size is replaced with a document D having an irregular size (or vice versa).

Upon receiving the size mismatch notification from the scan controller 120, the main controller 110 temporarily stops the job. Specifically, the scan controller 120 temporarily stops the document transportation action performed by the document transportation unit 1 and the image-reading action performed by the image-reading part 2.

Although the main controller 110 temporarily stops the job, the settings inputted into the operation panel 8 prior to the start of the job are maintained without being reset (i.e., the job is not cancelled). The main controller 110 commands the operation panel 8 to issue a notification prompting the user to reset the document D on the document-loading tray 11 and/or prompting the user to input a setting for setting the reading size into the operation panel 8.

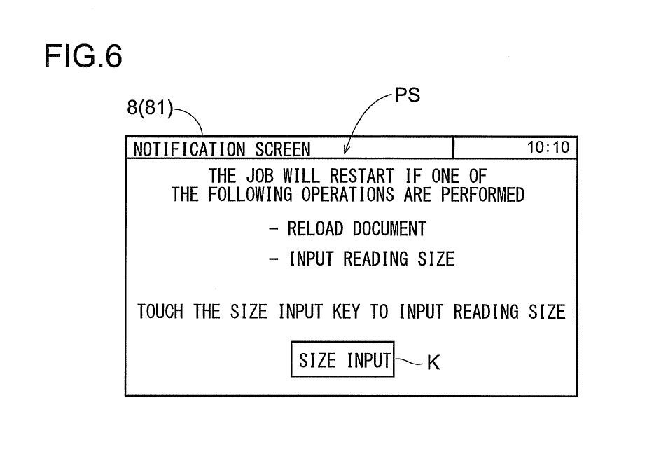

For example, the operation panel 8 displays a notification screen PS such as that shown in FIG. 6. A message prompting the user to reload the document D, a message prompting the user to input the setting for the reading size, and the like are placed on the notification screen PS. In addition, a key K for switching to a screen for inputting the reading size is placed on the notification screen PS. When the key K is touched, the operation panel 8 displays the size setting screen PS1 (see FIG. 4) or the size setting screen PS2 (see FIG. 5).

When the document D is reloaded on the document-loading tray 11, the scan controller 120 detects the size of the document D reloaded on the document-loading tray 11 on the basis of the output values from the document size sensors S1-S4. The scan controller 120 also notifies the main controller 110 of document size information indicating the size of the document D reloaded on the document-loading tray 11. Upon receiving the notification of the document size information, the main controller 110 resets the reading size on the basis of the size of the document D reloaded on the document-loading tray 11. Then, the main controller 110 restarts the job, maintaining settings relating to the job other than the reading size (i.e., makes an image-reading request to the scan controller 120).

It is thereby possible to cut the amount of operation performed by the user (operation of re-inputting the settings inputted into the operation panel 8 prior to the start of the job) when restarting a job (e.g., a transmission job or a copy job) that has stopped temporarily. Accordingly, the convenience for the user is improved. In addition, merely reloading the document D on the document-loading tray 11 restarts the job while maintaining the settings relating to the job other than the reading size; therefore, the convenience for the user is further improved.

Some users may load an irregular-sized document D on the document-loading tray 11. In such an instance, it is necessary to input a setting (arbitrary value) for the reading size into the operation panel 8. When the setting for the reading size is inputted into the operation panel 8, the main controller 110 resets the reading size on the basis of the setting inputted into the operation panel 8, irrespective of the size of the document D loaded on the document-loading tray 11. The main controller 110 then restarts the job while maintaining settings relating to the job other than the reading size (i.e., makes an image-reading request to the scan controller 120). When the size of the document D reloaded on the document-loading tray 11 is irregular, the job is restarted only when the setting for the reading size is inputted into the operation panel 8.

Such a feature in which a job is restarted by inputting the setting for the reading size into the operation panel 8 is convenient for a user wishing to perform a job in which an irregular-sized document D is read. In such an instance, there is a need to input the setting for the reading size, but there is no need to input settings relating to the job other than the reading size. Therefore, the number of operations performed by the user is reduced.

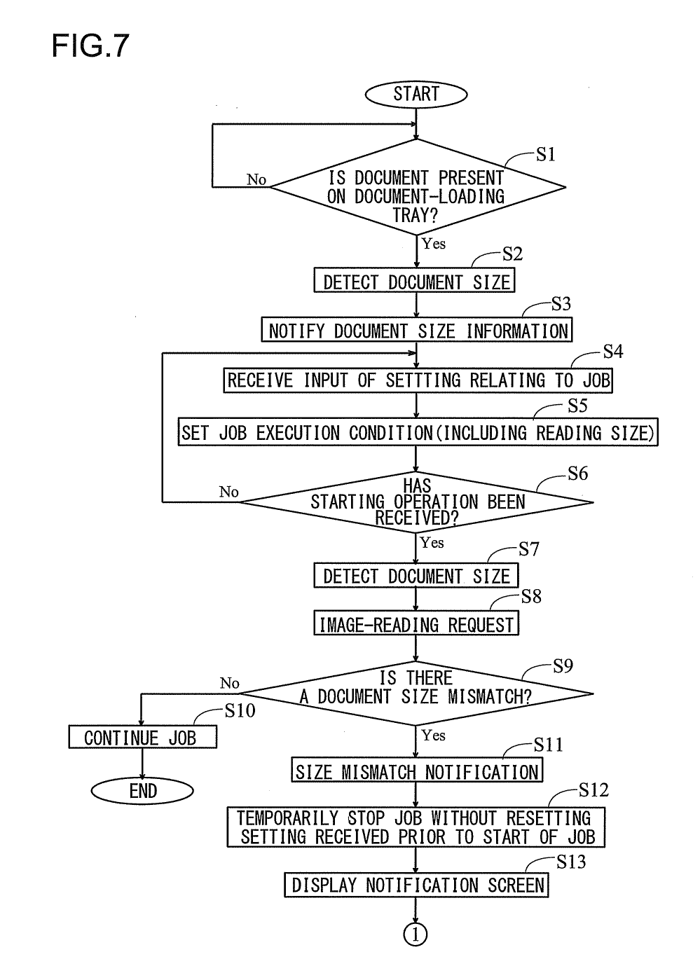

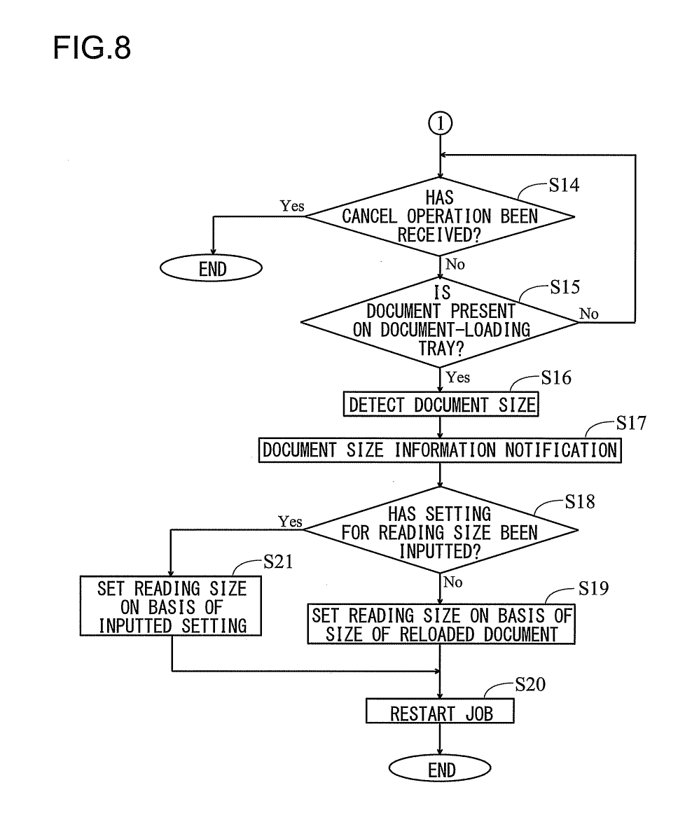

A control flow for executing a job involving transporting-reading will now be described in detail with reference to the flow charts shown in FIGS. 7 and 8. The start of the flow charts shown in FIGS. 7 and 8 corresponds to when the copier 100 has launched and execution of a job has become possible.

In step S1, the scan controller 120 determines, on the basis of the output value from the document loading sensor SS, whether or not a document D is present on the document-loading tray 11 (i.e., whether or not a document D has been loaded on the document-loading tray 11). When a document D is present on the document-loading tray 11, the flow proceeds to step S2, and when a document D is not present on the document-loading tray 11, the determination in step S1 is repeated.

When the flow proceeds to step S2, the scan controller 120 detects the size of the document D loaded on the document-loading tray 11 on the basis of the output values from the document size sensors S1-S4. Then, in step S3, the scan controller 120 notifies the main controller 110 of document size information indicating the size of the document D loaded on the document-loading tray 11.

Next, in step S4, upon receiving the notification of the document size information, the main controller 110 causes the operation panel 8 to receive an input of settings relating to the job. Specifically, the operation panel 8 displays a setting screen for receiving an input of settings relating to the job.

Next, in step S5, the main controller 110 sets job execution conditions (including the reading size) on the basis of the settings received by the operation panel 8. When the setting for the reading size is set to “automatic”, the main controller 110 sets the reading size on the basis of the size of the document D loaded on the document-loading tray 11. Alternatively, when the setting for the reading size is inputted into the size setting screen PS1 (see FIG. 4) or the size setting screen PS2 (see FIG. 5), the main controller 110 sets the reading size on the basis of the inputted setting.

Next, in step S6, the main controller 110 determines whether or not the operation panel 8 has received a starting operation. When, as a result, it is determined that the operation panel 8 has received a starting operation, the flow proceeds to step S7. The point at which the job is started is when the operation panel 8 receives the starting operation. When the operation panel 8 has not received a starting operation, the flow proceeds to step S4. Each time a document D is replaced or a setting is changed before the operation panel 8 receives a starting operation, the main controller 110 changes the setting for the job execution condition.

When the flow proceeds to step S7, the main controller 110 commands the scan controller 120 to detect the size of the document D loaded on the document-loading tray 11 at least until the document transportation unit 1 starts a document transportation action. Then, in step S8, the main controller 110 makes an image-reading request to the scan controller 120.

Next, in step S9, upon receiving the image-reading request, the scan controller 120 determines whether or not there is a difference in the size of the document D (i.e., whether or not there is a size mismatch) before and after the starting operation performed on the operation panel 8. When, as a result, it is determined that there is no difference in the size of the document D before and after the starting operation performed on the operation panel 8, the flow proceeds to step S10. When the flow proceeds to step S10, the scan controller 120 notifies the main controller 110 that image-reading will be performed. Upon receiving this notification, the main controller 110 continues the job.

In contrast, when, in step S9, there is a difference in the size of the document D before and after the starting operation performed on the operation panel 8, the flow proceeds to step S11. When the flow proceeds to step 811, the scan controller 120 notifies the main controller 110 of a size mismatch. Then, in step S12, upon receiving the size mismatch notification, the main controller 110 stops the job temporarily without resetting the settings received by the operation panel 8 prior to the start of the job.

Next, in step S13, the main controller 110 causes the operation panel 8 to display a notification screen PS (see FIG. 6). Then, in step S14, the main controller 110 determines whether or not a cancel operation for cancelling the temporarily stopped job has been received by the operation panel 8. When, as a result, it is determined that the operation panel 8 has received the cancel operation, the job is terminated without being restarted (i.e., the settings inputted into the operation panel 8 prior to the start of the job are reset). In contrast, when the operation panel 8 has not received the cancel operation, the flow proceeds to step S15.

When the flow proceeds to step S15, the main controller 110 commands the scan controller 120 to determine whether or not a document is present on the document-loading tray 11 (i.e., whether or not a reloaded document D is present on the document-loading tray 11). Specifically, the scan controller 120 determines whether or not, after the starting operation has been performed on the operation panel 8, the output value from the document loading sensor SS has shifted from a level indicating the presence of the document D to a level indicating an absence of the document D and subsequently to the level indicating the presence of the document D. When, as a result, the scan controller 120 determines that a document D is present on the document-loading tray 11, the flow proceeds to step S16, and when the scan controller 120 determines that no document D is present on the document-loading tray 11, the flow returns to step S14.

When the flow proceeds to step S16, the main controller 110 causes the scan controller 120 to detect the size of the document D reloaded on the document-loading tray 11. Then, in step S17, the scan controller 120 notifies the main controller 110 of document size information indicating the size of the document D reloaded on the document-loading tray 11.

Next, in step S18, upon receiving the notification of the document size information, the main controller 110 determines whether or not a setting for setting the reading size has been inputted into the operation panel 8. When, as a result, it is determined that the setting for the reading size has not been inputted into the operation panel 8, the flow proceeds to step S19. When the flow proceeds to step S19, the main controller 110 sets the reading size on the basis of the size of the document D reloaded on the document-loading tray 11. Then, in step S20, the main controller 110 restarts the job while maintaining the settings relating to the job other than the reading size (i.e., makes an image-reading request to the scan controller 120).

When, in step S18, the setting for the reading size has been inputted into the operation panel 8, the flow proceeds to step S21. When the flow proceeds to step S21, the main controller 110 sets the reading size on the basis of the setting inputted into the operation panel 8. Then, the flow proceeds to step S20. In other words, the main controller 110 restarts the job while maintaining the settings relating to the job other than the reading size (i.e., makes an image-reading request to the scan controller 120).

The above configuration may also be such that after the job is temporarily stopped, only a notification prompting the user to reload the document D is issued, the reading size is set on the basis of the size of the reloaded document D, and the job is restarted. However, the job may be terminated without being restarted when the size of the document D reloaded on the document-loading tray 11 is irregular.

Alternatively, the configuration may be such that after the job is temporarily stopped, only a notification prompting the user to input the setting for setting the reading size, the reading size is set on the basis of the inputted setting, and the job is restarted.

The embodiment disclosed herein is an example in all respects, and should not be considered to be provided by way of limitation. The scope of the present disclosure is indicated by the claims and not by the description of the above embodiment, and includes all modifications within the meaning and scope equivalent to those of the claims.

1. An image-reading device, comprising:
an operation part for receiving an input of a setting relating to a job, and receiving a starting operation for starting the job;
a document-loading tray on which a document is loaded;
a document transportation part for transporting the document loaded on the document-loading tray to a reading position during execution of the job;
an image-reading part for reading the document passing through the reading position during execution of the job;
a document size sensor for detecting the size of the document loaded on the document-loading tray; and
a controller for detecting the size of the document on the basis of an output value from the document size sensor when the document is loaded on the document-loading tray, starting the job when the starting operation is performed on the operation part, and controlling the execution of the job in accordance with the setting received by the operation part prior to the start of the job;
the controller detecting, after the starting operation is performed on the operation part, the size of the document loaded on the document-loading tray, and when there is a difference between the size of the document detected prior to the starting operation and the size of the document after the starting operation, temporarily stopping the job without resetting the setting received by the operation part prior to the start of the job.

2. The image-reading device according to claim 1 comprising a notification part for issuing a notification of a job execution state;
the notification part issuing, when the job is temporarily stopped by the controller, a notification prompting the user to reload a document on the document-loading tray; and
when a document is reloaded on the document-loading tray, the controller setting, on the basis of the size of the document reloaded on the document-loading tray, a reading size by which the image-reading part reads the document, and restarting the job while maintaining a setting relating to the job other than the reading size.

3. The image-reading device according to claim 2,
the notification part including a display part for displaying information, and
the display part displaying, when the job is temporarily stopped by the controller,
a message prompting [the user] to reload a document on the document-loading tray.

4. The image-reading device according to claim 1 comprising a notification part for issuing a notification of a job execution state;
the notification part issuing, when the job is temporarily stopped by the controller, a notification prompting the user to input, into the operation part, a setting for setting a reading size by which the image-reading part reads the document; and
when the setting for setting the reading size is inputted into the operation part, the controller setting the reading size on the basis of the setting inputted into the operation part irrespective of the size of the document loaded in the document-loading tray, and restarting the job while maintaining a setting relating to the job other than the reading size.

5. The image-reading device according to claim 4,
the notification part including a display part for displaying information, and
the display part displaying, when the job is temporarily stopped by the controller,
a message prompting the user to input, into the operation part, a setting for setting the reading size.

6. A communication device comprising:
the image-reading device according to claim 1; and
a communication part communicably connected to an external device, the communication part transmitting, to the external device, image data obtained by the document being read by the image-reading part,
the job being a transmission job for transmitting, to the external device, the image data corresponding to the document.

7. An image-forming device comprising:
the image-reading device according to claim 1; and
a printing part for printing, onto paper, an image based on image data obtained by the document being read by the image-reading part,
the job being a copy job for printing, onto paper, the image based on the image data corresponding to the document.
